(19) United States
(12) Patent Application Publication
(10) Pub. No.: US 2025/0096458 A1
(43) Pub. Date: Mar. 20, 2025

(54) Millimeter Wave Backscatter Network for Two-Way Communication and Localization

(71) Applicant: The Regents of the University of California, Oakland, CA (US)

(72) Inventors: Omid Salehi-Abari, Oakland, CA (US); Mohammad Hossein Mazaheri Kalahrody, Oakland, CA (US); Haofan Lu, Oakland, CA (US)

(73) Assignee: The Regents of the University of California, Oakland, CA (US)

(21) Appl. No.: 18/886,860

(22) Filed: Sep. 16, 2024

Related U.S. Application Data
(60) Provisional application No. 63/582,779, filed on Sep. 14, 2023.

(51) Int. Cl. H01Q 3/22; G01S 13/42; H01Q 1/50; H01Q 21/06

(52) U.S. Cl. CPC H01Q 3/22; G01S 13/426; H01Q 1/50; H01Q 21/06

(57) ABSTRACT

In some embodiments of the invention, a millimeter wave (mmWave) backscatter network node includes a frequency scanning antenna (FSA) having at least one port, the FSA including an array of emitting elements such that, given an incoming signal resulting in emitting signal from the emitting elements, the direction in which emitting signals combine constructively changes with the frequency of the incoming signal, and a radio frequency (RF) signal processing unit configured to measure strength and determine frequency of a received signal that is received by a first port of the FSA.

### CROSS-REFERENCE TO RELATED APPLICATIONS

The current application claims priority to U.S. Provisional Application No. 63/582,779, filed Sep. 14, 2023, the disclosure of which is incorporated herein by reference.

### FIELD OF THE INVENTION

The present invention relates generally to wireless communications and more specifically to communication and localization using millimeter wave signals.

### BACKGROUND OF THE INVENTION

Millimeter wave (mmWave) technology enables wireless devices to communicate using very high-frequency signals. mmWave refers to very high frequency (typically 24 GHz to 100 GHz) signals. Over the past decade, there has been much interest in using this technology in wireless networks. mmWave networks have three advantages over traditional wireless networks. First, they provide much higher network throughput since they can benefit from a large bandwidth available in the high-frequency spectrum. In fact, the Federal Communications Commission (FCC) has released more than 14 GHz of bandwidth for both licensed and unlicensed use in the mm Wave frequency bands above 24 GHZ, which is orders of magnitude more than the bandwidth allocated to today's WiFi networks. Second, mmWave networks can provide connectivity to many nodes simultaneously on the same frequency band. In particular, due to the small wavelength of mmWave signal (millimeter scale), mmWave antennas are tiny and hence it is possible to pack hundreds of antennas in a small area, creating an antenna array with a very directional beam. Using directional beams for communication enables mmWave networks to perform space division multiplexing to support multiple links simultaneously, on the same frequency band. Third, thanks to the short wavelength of mmWave signals, and the availability of large bandwidth and narrow beams, mmWave networks can perform very accurate localization (both range and direction) of their devices, which has the potential to open up many new opportunities and applications.

Despite the above advantages, existing mmWave networks have a major limitation that makes them unsuitable for many IoT applications. Radios operating at high-frequencies such as mmWave have high power consumption, restricting their use in devices with limited energy sources.

The problem is intrinsic, as the power consumption of Radio Frequency (RF) circuits is proportional to their operating frequencies, and therefore most components of a radio, such as mixers and oscillators, consume much more power when they run at such high frequencies. Additionally, in contrast to traditional radios, mmWave radios require steerable directional antennas (such as phased arrays), which significantly increase the power consumption of these radios.

To overcome the high power consumption problem of mm Wave networks, researchers have designed mmWave backscatter devices. The vision is to design mmWave devices that can piggyback their data on a mmWave signal emitted by an access point (AP), instead of generating and transmitting their own signals. Eliminating the need for an active transmitter and power-hungry RF components has enabled mm Wave backscatter devices to communicate on a very low energy budget. However, exiting mmWave backscatter devices enable either accurate localization or only uplink communication. Hence, they cannot be used in applications which need both uplink and downlink connectivity such as Virtual Reality (VR) and Augmented Reality (AR). No current mmWave backscatter system enables localization, uplink, and downlink communications altogether.

### SUMMARY OF THE INVENTION

In many embodiments of the invention, a millimeter wave (mmWave) backscatter network node includes a frequency scanning antenna (FSA) having at least one port, the FSA including an array of emitting elements such that, given an incoming signal resulting in emitting signal from the emitting elements, the direction in which emitting signals combine constructively changes with the frequency of the incoming signal, and a radio frequency (RF) signal processing unit configured to measure strength and determine frequency of a received signal that is received by a first port of the FSA.

In some embodiments of the invention, the first RF signal processing unit includes a first switch connected to the first port of the FSA and configured to switch the first port between a connection to ground and a connection to a first envelope detector, and a microcontroller connected to the first envelope detector.

In additional embodiments of the invention, the FSA is a dual-port FSA having two ports, and the node further comprises a second RF signal processing unit configured to measure strength and determine frequency of a received signal that is received by a second port of the FSA.

In further embodiments of the invention, the second RF signal processing unit includes a second switch connected to a second port of the FSA and configured to switch the second port between a connection to ground and a connection to a second envelope detector, and the second envelope detector is connected to the microcontroller.

In still more embodiments of the invention, the microcontroller controls the states of the first switch and second switch.

In still further embodiments of the invention, the FSA is configured to reflect an incoming signal when the first switch connects the first port to ground and the second switch connects the second port to ground.

In some embodiments of the invention, the FSA is configured to absorb an incoming signal and passes it the first envelope detector and second envelope detector when the first switch connects the first port to the first envelope detector and the second switch connects the second port to the second envelope detector.

In additional embodiments of the invention, the first RF signal processing unit is configured to receive a triangular frequency modulated continuous wave (FMCW) signal through the FSA from an access point (AP), measure a delay between two times the node receives the highest power of the FMCW signal, and determine an orientation of the node with respect to the AP based on the measured delay.

In further embodiments of the invention, the first RF signal processing unit is further configured to determine at least one bit of information based upon the strength and frequency of the received signal.

In still more embodiments of the invention, the FSA structure is dual-port and symmetric such that it is configured to create two sets of beams whose frequency assignments based on direction mirror each other.

### BRIEF DESCRIPTION OF THE DRAWINGS

FIG. 1 illustrates a Frequency Scanning Antenna (FSA) in accordance with embodiments of the invention.

FIG. 2 illustrates a FMCW radar chirp signal in accordance with embodiments of the invention.

FIG. 3 illustrates an FCA structure with two ports in accordance with embodiments of the invention.

FIG. 4 illustrates a block diagram of a backscatter node in accordance with some embodiments of the invention.

FIG. 5 illustrates a process for location detection using mmWave backscatter nodes in accordance with embodiments of the invention.

FIG. 6 illustrates a process for orientation estimation by an access point using mm Wave backscatter nodes in accordance with embodiments of the invention.

FIG. 7 illustrates a process for orientation estimation by a backscatter node using mmWave backscatter nodes in accordance with embodiments of the invention.

FIG. 8 shows a graph of a V-shaped chirp signal frequency over time on top and a graph of the delay between the two times when the node receives the highest voltage in a received signal on bottom.

FIG. 9 illustrates data symbols that can be represented by combinations of frequencies in accordance with embodiments of the invention.

FIG. 10 illustrates a block diagram of an access point in accordance with some embodiments of the invention.

FIG. 11 illustrates a process for receiving a reflected signal by an access point in accordance with some embodiments of the invention.

FIG. 12 conceptually illustrates a data packet in accordance with some embodiments of the invention.

### DETAILED DISCLOSURE OF THE INVENTION

Turning now to the drawings, mmWave backscatter networks that enable both two-way communication (uplink and downlink) and localization are disclosed. Backscattering is the most energy-efficient wireless communication technique, where nodes piggyback their data on an access point's signal instead of generating their own signals. Eliminating the need for signal generation significantly reduces the energy-consumption of the nodes. In contrast to past mm Wave backscatter works which support only uplink, embodiments of the invention can support uplink, downlink, and accurate localization. Addressed are the key challenges that prevent existing backscatter networks to enable both uplink and downlink at mmWave bands. Some implementations of certain embodiments of the invention have been shown to be capable of achieving accurate localization, uplink, and downlink communication at up to 8 m while consuming only 32 mW and 18 mW, respectively.

mm Wave backscatter networks in accordance with some embodiments of the invention include a novel backscatter node and an access point (AP). Both uplink and downlink communication are supported between its AP and nodes. It also enables accurate localization and orientation sensing of nodes. Embodiments of the invention can achieve this by multiple innovations.

Two-Way Backscatter Communication and Localization: A first challenge is to develop a low-power backscatter node which can enable two-way communication and localization. To achieve this, many embodiments of the invention utilize a novel backscatter node architecture, including a passive mmWave structure that creates two directional beams that can operate in absorptive or reflective mode. In the absorptive mode, the node receives the AP's signal using its two beams and passes it to its baseband processor for demodulation. This enables downlink communication from the AP to the node. In the reflective mode, each beam reflects only a specific frequency component of the AP's signal back to the AP, where these frequencies depend on the orientation of the node with respect to the AP. This enables the AP to estimate the location and orientation of the node by transmitting a wide-band signal and monitoring which frequencies are reflected back to it. Finally, by switching the beams' mode between reflective and absorptive, the node can modulate the AP's signal and reflects it back to the AP, supporting uplink communication.

Orientation Assisted Quadrature Frequency Modulation (OAQFM): A second challenge is to develop a modulation scheme that enables the backscatter node to modulate or demodulate signals using a very simple and low-power baseband processor. To achieve this, many embodiments of the invention utilize a new modulation scheme called Orientation Assisted Quadrature Frequency Modulation (OAQFM).

Typical modulation schemes (such as QAM) use cosine and sine (with the same frequency) to present complex symbols, and hence they require a mixer and oscillator to separate the cosine and sine components and modulate/demodulate the signal. Unfortunately, due to the complexity and power consumption of these components, these modulation schemes are not suitable for mmWave backscatter nodes. In contrast, OAQFM, instead of using cosine and sine, uses two cosines (tones) but at different frequencies to represent complex symbols. In certain embodiments of the invention, this enables a node to receive these tones from the AP using its beams, and then modulate or demodulate it using simple low-power envelope detectors (power detectors) integrated at the output of its passive directional reflector/absorber.

Many embodiments of the invention include a mmWave backscatter network that enables uplink, downlink, and accurate localization of its backscatter devices. A network can include an access point (AP) and one or more multiple backscatter nodes. Nodes in certain embodiments of the invention may operate in two modes: reflective and absorptive. In the reflective mode, it reflects the AP's signal back to the AP. This enables the AP to accurately estimate the distance, direction and orientation of the nodes. In several embodiments of the invention, the AP can use directional antennas to create transmitting and receiving beams. Then, it steers these beams together while transmitting its signal. When the beams are facing toward a node, the node reflects the signal back to the direction of arrival (i.e., direction of the AP). The AP receives the backscattered signal and can accurately estimate the distance, direction, and orientation of the node using, for example, frequency modulated continuous wave (FMCW) radar. The network can exploit the orientation information of the node and enable both uplink and downlink communication between its nodes and AP using its novel low-power design and modulation scheme.

Next are discussed frequency scanning antenna (FSA) and frequency modulated continuous wave (FMCW) technologies, which are utilized in several embodiments of the invention.

### Frequency Scanning Antenna

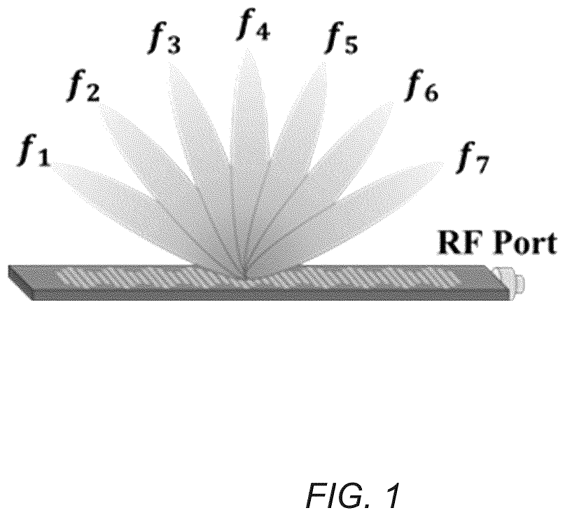

Frequency Scanning Antenna (FSA) is a passive structure that creates a beam whose direction depends on the frequency of the signal that is input or output, as shown in FIG. 1. Said differently, as the frequency of the received/transmitted signal changes, the direction of the beam changes as well. Moreover, if the signal includes two or multiple different frequencies, the structure creates two or multiple different beams, where the direction of each beam corresponds to that specific frequency. FSA structure typically includes of an array of emitting elements. As the signal propagates through the structure, it experiences phase shifts between the consecutive emitting elements. Accordingly, the emitting signals will combine constructively over the air, creating a beam. However, as the frequency of the signal changes, the amount of phase shift between two consecutive emitting elements changes as well. Therefore, the direction in which signals combine constructively (i.e. the direction of the beam) will change with the frequency of the signal. FSA has been mostly used in imaging and weather radars to enable multi-dimensional environment sensing and imaging. Recently, it has also been used to enable passive beamforming for relays. Many embodiments of the invention include a dual-port mm Wave FSA that can achieve passive and low-power beamforming for backscatter networks. Several embodiments can cover a 60 azimuth angle using only 3 GHz bandwidth.

### Frequency Modulated Continuous Wave

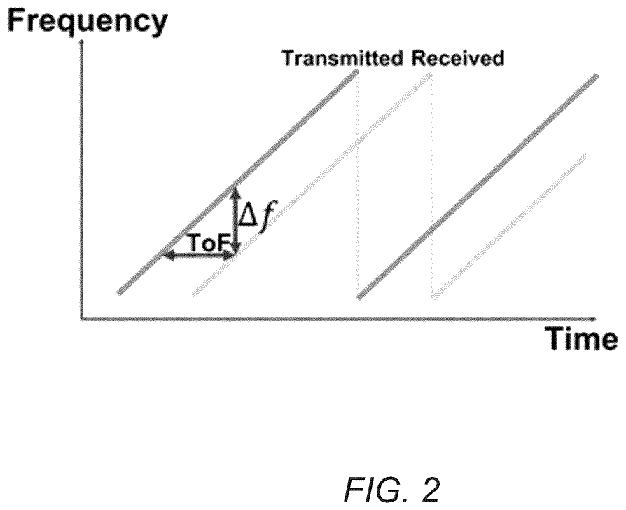

Frequency Modulated Continuous Wave (FMCW) radar is a wireless sensing technology that can measure the distance of objects from itself by transmitting a signal and measuring the reflection from the objects. To do so, the FMCW radar transmits a chirp signal whose frequency changes linearly with time as shown in FIG. 2. This signal goes over the air and is reflected back by an object. The radar receives the reflected signal and compares its frequency to that of the transmitted signal. This comparison can be done by multiplying the transmitted signal with the received signal and checking the frequency of the result. Note, since the transmitted signal frequency is changing linearly in time, delays in the reflected signals translate into frequency shifts in comparison to the transmitted wave as shown in FIG. 2. Therefore, by comparing the frequency difference between the transmitted signal and the received signal, one can discover the time delay that the signal incurred which corresponds to the time-of-flight (ToF) from the radar device to the object. In particular, ToF can be calculated as follow: ToF=Δf|slope, where Δf is the measured frequency difference between the transmitted and received signal, and slope is the slope of the frequency sweep as shown in FIG. 2. Finally, once the ToF is computed, the radar can estimate the round-trip distance of the object from itself by multiplying the ToF with the speed of light. Note, although the above description is for a single object, it can be extended to an environment with multiple objects.

mmWave Backscatter Network Node

Due to the high-frequency nature of mmWave signals, these signals decay quickly with distance. Hence, a backscatter node operating at mmWave frequency should focus its reflected power into a narrow beam toward the AP in order to compensate for the path loss. Otherwise, the AP may not receive the node's reflected signal. A typical approach to create and steer beams in mmWave nodes is to use phased arrays. However, phased arrays are too complex and power hungry to be used in a low-power backscatter node. The Van Atta technique could be used to create a beam in backscatter nodes. Van Atta is an array of antennas that are connected to each other through transmission line traces. This passive structure can create a beam and reflect signals in the same direction as their arrival direction. However, Van Atta is not suitable for providing uplink and downlink together. In particular, Van Atta designs are targeted only for reflecting signals and they cannot be used for receiving since the do not have any signal ports.

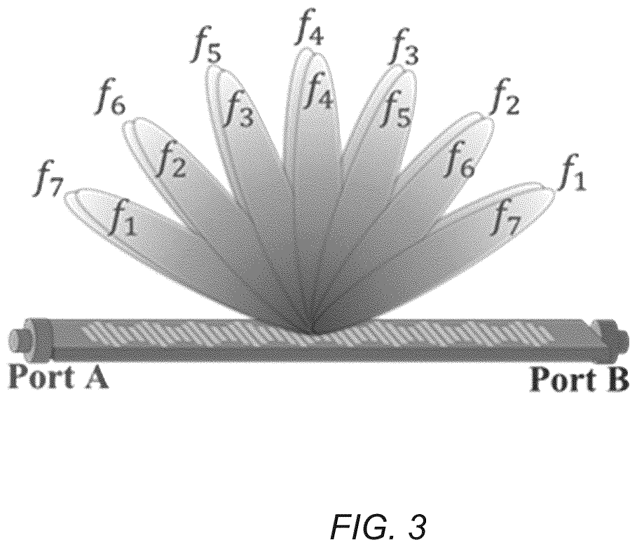

Many embodiments of the invention utilize an FSA structure in the backscatter node(s). However, in contrast to a typical FSA, several embodiments of invention implement a dual-port FSA that creates two sets of beams whose frequency assignments mirror each other (i.e., are reversed or symmetric). The FSA structure is symmetric, hence adding a second port to the other side of the FSA structure can enable two sets of beams such as the example shown in FIG. 3. The red beams are created by Port A and the blue beams are created by Port B. Therefore, for each direction, there will be two beams that correspond to different frequencies. For instance, in FIG. 3, the rightmost beam corresponds to frequency f₁ for Port A and frequency f₇ for Port B. As will be described further below, this dual-port FSA enables sensing the orientation of nodes as well as supports higher data-rate uplink and downlink communication.

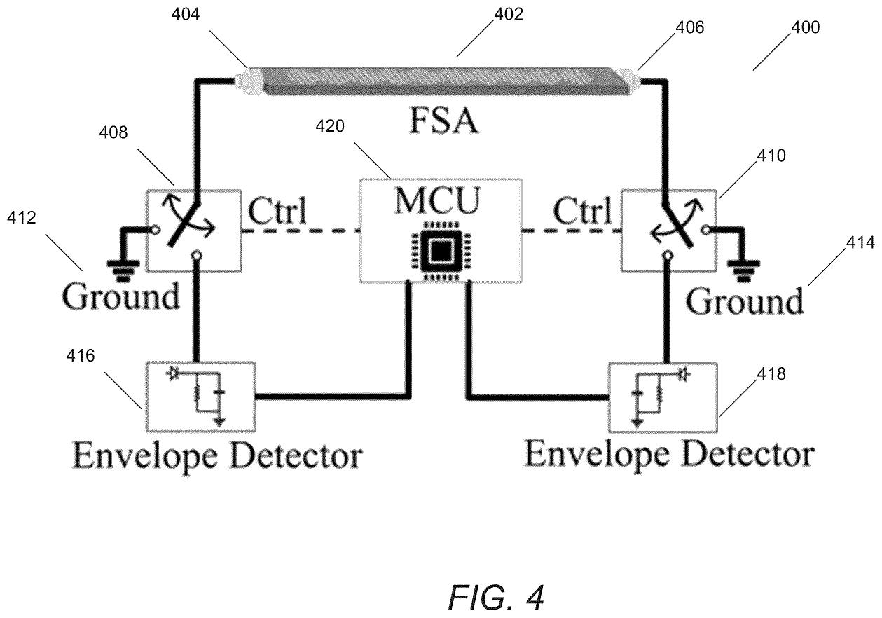

FIG. 4 shows a block diagram of a backscatter node in accordance with some embodiments of the invention. The backscatter node 400 includes a dual-port FSA antenna 402 where each of its ports 404 and 406 is connected to a switch 408 and 4101, respectively. Each switch connects the FSA port to either the ground plane 412 and 414 of the FSA (i.e., short circuit) or an envelope detector 416 and 418. When the FSA ports 404 and 406 are connected to the ground, the FSA's beam reflects the signal back to the AP. On the other hand, when the FSA ports 404 and 406 are connected to the envelope detectors 416 and 418, the FSA's beam absorbs the AP's signal and passes it to the envelope detectors 416 and 418. Hence, the node does not reflect any signals. This is because the envelope detector has a 50-ohm input impedance, which is matched with the impedance of the FSA's port. Finally, the outputs of the envelope detectors 416 and 418 are connected to the ADC pin of a micro-controller unit (MCU) 420 which can also control the switches 408 and 410. Such a design can be low-cost and low-power. It does not need to use any costly and power-hungry mmWave components such as phased arrays, phase shifters, amplifiers, oscillators, or mixers. In some embodiments, the main components of a node include just two envelope detectors, two switches, and a low-power processor unit (such as a micro-controller).

While a specific architecture of backscatter node is described above with respect to FIGS. 3 and 4, one skilled in the art will recognize that further variations are possible within embodiments of the invention as may be appropriate to a particular application. For example, as the illustrated design shows seven beams from each port, one skilled in the art will recognize that an FSA may be implemented with different numbers of beams in accordance with embodiments of the invention.

### Location Detection

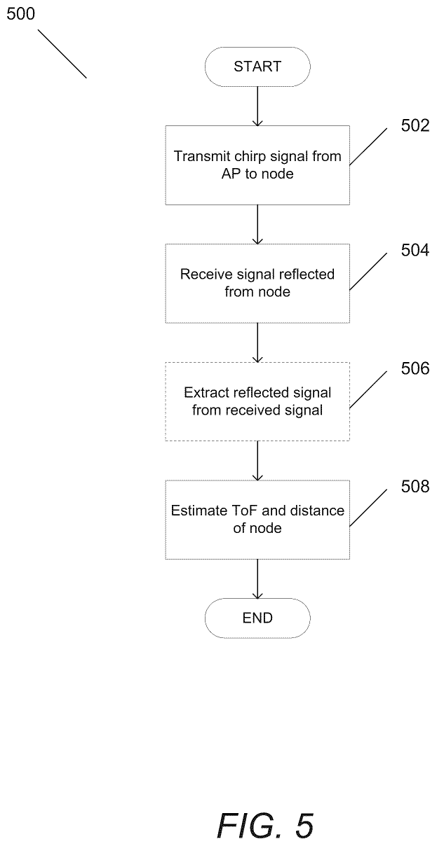

In certain embodiments of the invention, FMCW can be used to find the location of a node with respect to the AP as described further above. A process for location detection is illustrated in FIG. 5. In the illustrated process 500, the AP transmits (502) an FMCW chirp signal while the node is in reflective mode. The AP receives (504) a signal reflected from the node, which may be combined with the signal reflected off other objects in the environment. The AP may extract (506) the node's reflected signal from the reflection of the other objects in the environment. In particular, the node's reflection is much weaker than the reflection of some other objects. The AP uses the extracted reflected signal to estimate (508) the signal's time-of-flight and the distance of the node from the AP.

A technique can be used similar to the background subtraction technique used in radar systems. In some embodiments of the invention, the node switches between reflective and absorptive mode at a 10 KHz rate (i.e. modulating the reflected signal) while the AP is transmitting FMCW chirps. The AP then takes the Fast Fourier Transform (FFT) of the received signal of a set of consecutive chirps (e.g., five chirps), and subtracts every two pair from each other. It then uses the results of these subtractions to detect the node's reflected signal. Note, since the chirp duration is much shorter than any changes in the environment, the subtraction will remove the reflected signals of other objects. On the other hand, since the node's reflection is modulated, it may experience changes between consecutive chirps. Hence, the node's reflected signal would not be removed by subtraction. Using this technique, the AP can detect the node's reflection from the signal reflected by other objects, and estimate the distance of the node with respect to itself.

Although a specific process for detecting location of a node with respect to an AP is discussed above, one skilled in the art will recognize that any of a variety of processes may be utilized in accordance with embodiments of the invention.

### Orientation Detection

The orientation sensing of a node can be important for applications such as virtual reality (VR) and augmented reality (AB) in determining user's gesture and direction. In embodiments of the invention, either the AP or the node or both are able to estimate the orientation of the node with respect to the AP.

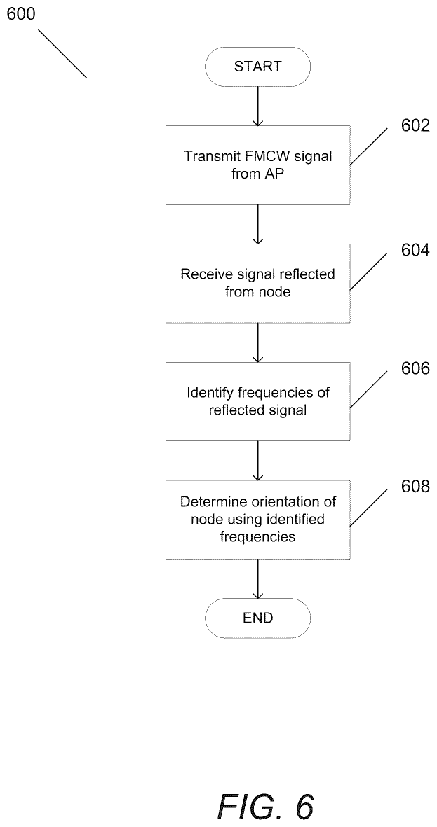

First, an AP may estimate the orientation of a node which is within range of the particularly frequency. A process for orientation estimation by an AP is illustrated in FIG. 6. The AP transmits (602) an FMCW signal while the node operates in the reflective mode. Recall that the node's beam direction depends on the frequency of the signal. Therefore, the node creates a reflective beam toward the AP only for some specific frequencies of the FMCW signal. Said differently, the node reflects (604) only some frequencies of the FMCW signal back to the AP where those frequencies depend on the orientation of the node with respect to the AP. The frequencies are identified (606) by the AP. The AP can estimate (608) the orientation of the node by monitoring which frequencies of the FMCW signal have resulted in the highest reflection power.

Similar to the localization process, here it can be desirable to distinguish between the node's reflected signal and the reflection by other objects. Therefore, one port of the node's FSA can be in absorptive mode and the other port can be switched between absorptive and reflective mode to create different reflected signals over time. This enables the AP to take the FFT of the signal and perform background subtraction. After removing the background, the AP then takes an IFFT (inverse fast Fourier transform) and measures the reflected signal power across the mm Wave FMCW band. This enables the AP to measure which signal frequency has resulted in the highest reflection power and use it to accurately estimate the orientation of the node.

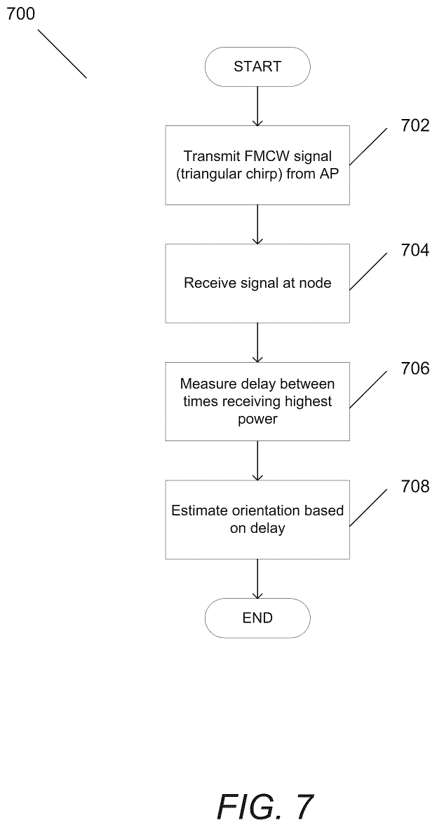

Second, a node may estimate its own orientation with respect to the AP. A process for orientation estimation by a node is illustrated in FIG. 7. The node can determine which one of its beams is aligned toward the AP. The node uses FSA to passively create beams where their directions depend on the frequency of the signal. Moreover, for the beams which are aligned toward the AP, the node receives the highest power from the AP. Therefore, there is a one-to-one correspondence between the orientation of the node and the signal frequency that results in the highest received power at the node. So the determination is how the node can measure which signal frequency results in the highest received power.

In certain embodiments of the invention, the AP transmits (702) an FMCW signal while the node is measuring (704) the received signal power using its envelope detector. Note, although the envelope detector can measure the received power, it may not be able to identify the frequency of the signal. Hence the node may not be able to detect which frequency has resulted in the highest received power.

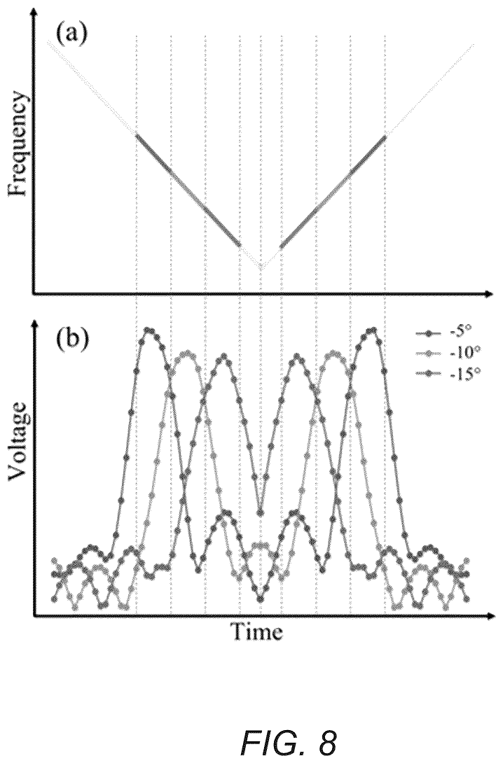

This is addressed in several embodiments of the invention that utilize a triangular (or V-shaped) chirp instead of a sawtooth chirp for the FMCW signal. In this case, although the node may not be able to measure the frequency of the signal which resulted in the highest received power, it can measure (706) the delay between the two times when the node receives the highest power, as in the example shown in FIG. 8. In particular, the V-shape property of the triangular chirp creates different delays between the two peaks in the received power where the amount of the delay depends on the orientation of the node. This enables the node to measure the delay and estimate (708) its orientation. This orientation information may be used at the AP to choose correct carrier frequencies for both uplink and downlink communication as discussed further below.

Although a specific process for orientation detection of a node with respect to an AP is discussed above, one skilled in the art will recognize that any of a variety of processes may be utilized in accordance with embodiments of the invention.

### Downlink Communication

Due to the significant path loss of mmWave signals, mmWave transmitters and receivers should focus their energy into narrow beams to compensate for the loss. Therefore, communication is possible when transmitter and receiver beams are aligned. When a node uses a dual-port FSA as discussed further above to passively create two beams, in certain embodiments the direction of each beam depends on the signal frequency and the signal of each beam is received by only one of the ports. Accordingly, the AP should know which two signal frequencies to use for communication.

In particular, one frequency aligns the beam for Port A of the FSA toward the AP while the other frequency aligns the beam for Port B of the FSA toward the AP. Note, these frequencies can be selected based on the orientation of the node. The AP may estimate the nodes' orientation by measuring the reflected signal power across different frequencies as described further above. The frequencies that resulted in the highest reflected power are the frequencies that have aligned the node beams toward the AP. Once the AP chooses the correct frequencies to align the node's beams toward the AP, it can then send signals at those frequencies which are received at two ports of the node's FSA. As shown in the embodiment of FIG. 4, each port is connected to a dedicated envelope detector which can enable a micro-controller to demodulate and decode the signal according to modulation schemes such as Orientation Assisted Quadrature Frequency Modulation (OAQFM) discussed below.

Although a specific technique for downlink communication is discussed above, one skilled in the art will recognize that variations may be utilized in accordance with embodiments of the invention.

### Orientation Assisted Quadrature Frequency Modulation

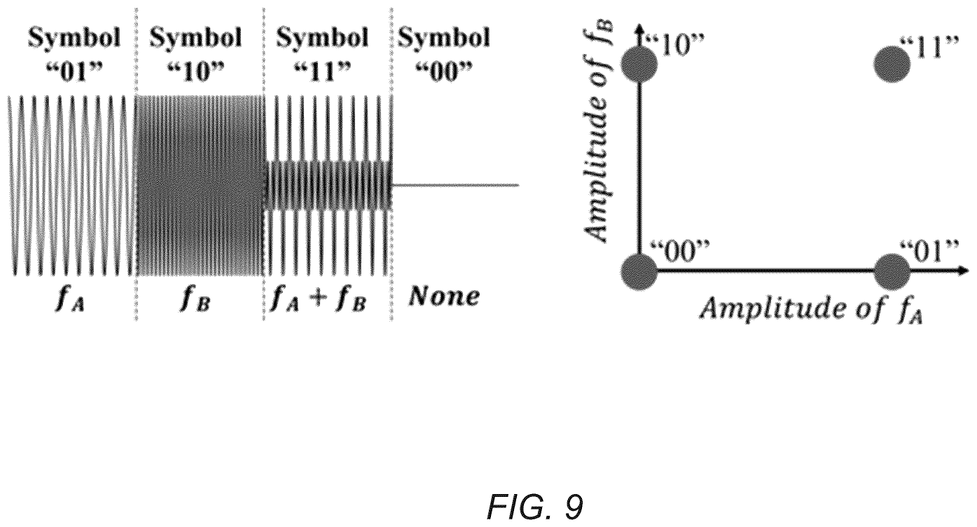

Many embodiments of the invention may utilize Orientation Assisted Quadrature Frequency Modulation (OAQFM). In this technique, the AP encodes its bits by modulating two carrier signals, where their frequencies are selected based on the orientation of the node. In certain embodiments, the presence or absence of each carrier signal can be used to present four different symbols, as shown in an example in FIG. 9. In this example, the AP has selected frequencies f_{A} and f_{B} for communication since these frequencies have aligned the node's beams toward the AP. Here, the AP transmits a single frequency f_{A} to represent a symbol of bits “01”, single frequency f_{B} for “10”, both frequencies f_{A} and f_{B} together for “11”, and none for “00”.

In many embodiments, on the node side, each port of the FSA is connected to a switch which can connect the FSA port to either ground or an envelope detector, as shown in FIG. 4. In the downlink mode, the switch connects the FSA ports to envelope detectors whose outputs are connected to a micro-controller. This enables the node to measure the power of the signal received by each port. Since each port receives only one of the carrier frequencies (f_{A} or f_{B}), the node can decode the bits by detecting the presence or absence of a signal at each of the two FSA ports.

In some situations, the node may be normal to the AP (i.e., a zero-incidence angle). In embodiments of the invention, the FSA's beams for port A and Port B would operate at the same frequency (i.e. f_{A}=f_{B}) with this arrangement. Hence, the AP would not be able to use two carrier frequencies and need to use a single carrier frequency. Therefore, when the AP and the node estimate the orientation of the node is normal to the AP according to techniques discussed above, they may utilize a single carrier on-off-keying (OOK) modulation in some embodiments instead of OAQFM.

Although a specific implementation of OAQFM is described above, one skilled in the art will recognize that variations are possible in accordance with embodiments of the invention. For example, different frequencies may be used and different combinations of frequencies may be used for different symbols (e.g., both frequencies for symbol 00 or a single frequency for symbol 11). Additional bits in each symbol may be represented by also considering different amplitudes for the frequency tones (e.g., different amplitudes as an additional dimension to vary). Additionally, components other than envelope detectors and microcontrollers may be utilized to decode received signals according to the modulation scheme. In some embodiments of the invention, the downlink data rate may reach 36 Mbps, which is mainly limited by the rise and fall time of the envelope detector. Thus a faster envelope detector may enable higher data rates.

### Uplink Communication

In many embodiments of the invention, backscattering may be used for uplink communication from nodes to an AP. The AP may transmit a query signal of two tones at frequencies that align the node's beams toward the AP. Then the node may use OAQFM modulation to piggyback its data onto the AP's query signal by selectively reflecting or absorbing each tone. For example, according to the scheme discussed above, to send ‘01’ to the AP, the node may reflect the tone at f_{A} while absorbing the tone at f_{B}. Similarly, to sending ‘10’ to the AP, the node may reflect the tone at f_{B} while absorbing the tone at f_{A}. Finally, to send ‘00’ the node may absorb both tones, and to send ‘11’ it may reflect both tones.

Additional techniques may be used for the node to change each beam to absorptive or reflective mode independently. Each FSA port has a switch that connects the port to either the ground plane or an envelope detector. Moreover, each port receives only one of the tones in the AP's query signal. Hence, when an FSA port is connected to the ground, the FSA reflects back the tone which corresponds to that specific port to the AP. On the other hand, when the FSA port is connected to the envelope detector, the FSA absorbs that tone since the input impedance of the envelop detector is matched with the impedance of the FSA's port. Therefore, the node can switch each beam to reflective or absorptive mode independently by connecting each FSA port to either ground or the envelope detector.

In many embodiments of the invention, when the AP receives the node's signal, it may first extract it from interference signals. There can be two types of interference here. The first is self-interference which can be caused by the AP itself. The AP receives the node's weak signal while transmitting a strong query signal. The second can be caused by the signals being reflected off other objects, such as walls and desks in the environment, which can also create interference to the node's signal. To mitigate this interference at the AP, the received signal may be multiplied with each tone of the AP's query and then the interference can be filtered out as follows.

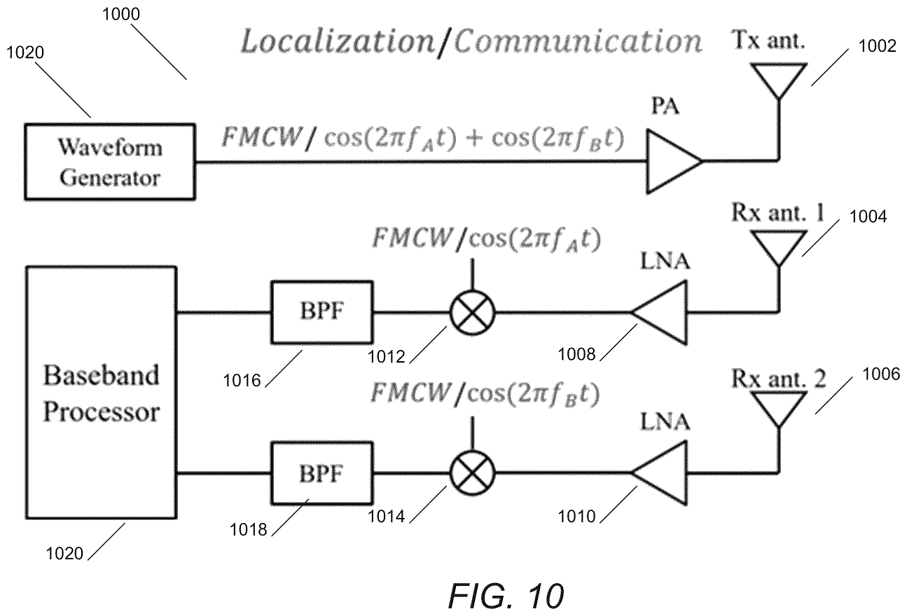

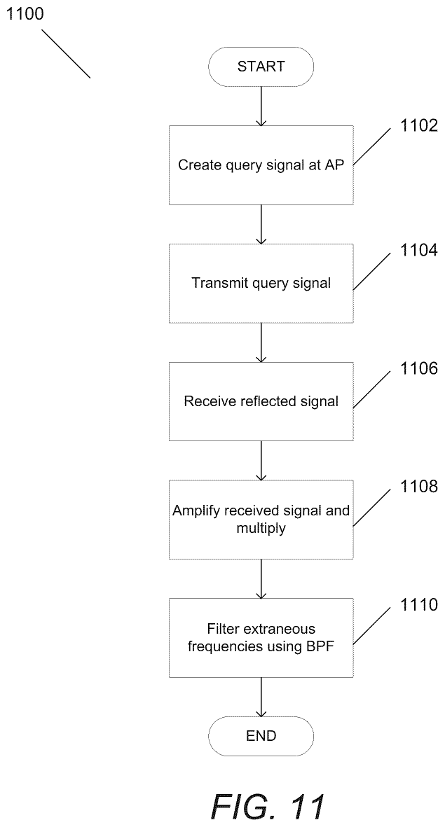

A block diagram of an AP in accordance with some embodiments of the invention is shown in FIG. 10 and a process for receiving a reflected signal by an AP is shown in FIG. 11. The AP 1000 may create (1102) a query signal of two tones (cos (2λf_{A}t)+cos(2πf_{B}t)) using a waveform generator 1020. The query signal may be transmitted (1104) from one antenna 1002 and reflected signals received using two antennas 1004 and 1006. The signal received (1106) at each receiving antenna is first amplified (1108) using an LNA 1008 and 1010 and then multiplied (1110) by one of the query signal's tones using a mixer 1012 and 1014. Since the interference signals (both the self-interference and reflection from surrounding objects) are just a delayed version of the transmitted signal, when they are multiplied by the tone (e.g. cos(2πf_{A}t)), the results will be a DC signal and some high-frequency signals (i.e. cos(2π2f_{A}t), ^{cos}(2^{πf}_{A}+B^{t}) and cos (2^{πf}_{A}−B^{t})) which can be easily filtered (1110) out using a band pass filter (BPF) 1016 and 1018. On the other hand, the node's reflected signal is the modulated version of the AP's transmitted signal. Hence, when the AP multiplies it by the tone, the results will be some high-frequency signals (which are filtered out using BPF) and the node's response at baseband frequency, which can be determined by baseband processor 1020. With this process, the AP can extract the node's response from interference signals.

In some embodiments, the uplink data rate is found to be up to 160 Mbps, which is generally limited by switching speed of the node's switches. Faster switches can enable a higher data rate and a larger FSA with higher gains can improve the range.

Although a specific technique for uplink communication is discussed above, one skilled in the art will recognize that variations may be utilized in accordance with embodiments of the invention.

### Joint Communication and Localization Protocol

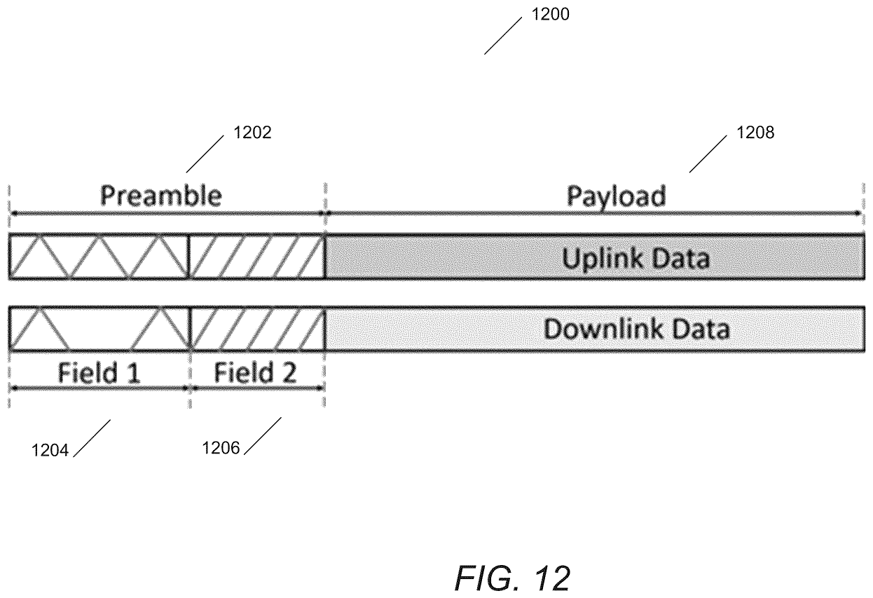

In many embodiments of the invention, a joint communication and localization protocol can enable localization and two-way communication together. In certain embodiments, a communication packet 1200 includes a preamble followed by a payload, such as shown in FIG. 12. The preamble 1202 includes two fields 1204 and 1206. The first field 1204 enables the node to estimate its orientation and inform the node whether the AP will send or receive data during the payload 1208. The second field 1206 enables the AP to localize the node. The payload 1208 can carry the uplink or downlink data.

In several embodiments of the invention, for the first field 1204 in the preamble the AP sends multiple triangular FMCW chirps while the node has its ports (beams) in the absorptive mode. This enables the node to sense its orientation, and for the AP to inform the node whether the system will operate in the uplink or downlink mode during the payload. For example, if the AP sends three chirps during this field, this can be taken to mean that the system operates in the uplink mode. In this case, during the payload 1208 part of the packet, the AP may send a query signal (two tones) while the node modulates it and sends its data to the AP as described further above. On the other hand, if the AP sends two chirps (with a gap in the middle, as shown in the FIG. 12) during the first field 1204, it can be taken to mean that the system operates in the downlink mode. In this case, during the payload 1208, the AP sends data and the node receives and decodes it as described further above.

During the second field 1206 of the preamble, as shown in FIG. 12, the AP may send five FMCW sawtooth chirps while the node switches its ports between the reflective and absorptive mode. This enables the AP to receive the node's reflection and localize it and sense its orientation as described further above. Following the preamble 1202, there will be a payload 1208 which can be used either for uplink or downlink. The length of the payload 1208 is predefined for both AP and the nodes, however, it can be adjusted based on the application and data-rate requirements. Finally, multiple nodes may be supported by using spatial division multiplexing (SDM) technique. The AP can create multiple beams towards different nodes and establish communication links with them concurrently.

Although a specific packet structure is described above with respect to FIG. 12, one skilled in the art will recognize that any of a variety of structures may be utilized in accordance with embodiments of the invention as appropriate to a particular application.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A millimeter wave (mmWave) backscatter network node comprising:
a frequency scanning antenna (FSA) having at least one port, the FSA comprising an array of emitting elements such that, given an incoming signal resulting in emitting signal from the emitting elements, the direction in which emitting signals combine constructively changes with the frequency of the incoming signal; and
a radio frequency (RF) signal processing unit configured to:
measure strength and determine frequency of a received signal that is received by a first port of the FSA.

2. The node of claim 1, wherein the first RF signal processing unit comprises:
a first switch connected to the first port of the FSA and configured to switch the first port between a connection to ground and a connection to a first envelope detector; and
a microcontroller connected to the first envelope detector.

3. The node of claim 1:
wherein the FSA is a dual-port FSA having two ports; and
the node further comprises a second RF signal processing unit configured to measure strength and determine frequency of a received signal that is received by a second port of the FSA.

4. The node of claim 3, wherein:
the second RF signal processing unit comprises a second switch connected to a second port of the FSA and configured to switch the second port between a connection to ground and a connection to a second envelope detector; and
where the second envelope detector is connected to the microcontroller.

5. The node of claim 4, wherein the microcontroller controls the states of the first switch and second switch.

6. The node of claim 4, wherein the FSA is configured to reflect an incoming signal when the first switch connects the first port to ground and the second switch connects the second port to ground.

7. The node of claim 4, wherein the FSA is configured to absorb an incoming signal and passes it the first envelope detector and second envelope detector when the first switch connects the first port to the first envelope detector and the second switch connects the second port to the second envelope detector.

8. The node of claim 1, wherein the first RF signal processing unit is configured to:
receive a triangular frequency modulated continuous wave (FMCW) signal through the FSA from an access point (AP);
measure a delay between two times the node receives the highest power of the FMCW signal; and
determine an orientation of the node with respect to the AP based on the measured delay.

9. The node of claim 1, wherein the first RF signal processing unit is further configured to:
determine at least one bit of information based upon the strength and frequency of the received signal.

10. The node of claim 1, wherein the FSA structure is dual-port and symmetric such that it is configured to create two sets of beams whose frequency assignments based on direction mirror each other.

11. A millimeter wave (mmWave) backscatter network access point (AP) comprising:
a waveform generator configured to generate a transmit signal;
a transmit antenna;
a first receive antenna connected to a first low noise amplifier (LNA), which is connected to a first mixer, which is connected to a first band pass filter (BPF), which is connected to a bandpass processor;
a second receive antenna connected to a second LNA, which is connected to a second mixer, which is connected to a second BPF, which is connected to the bandpass processor.

12. A method for estimating distance from a node to an access point in a mmWave backscatter network, the method comprising:
transmitting a chirp signal from an access point (AP) to a node;
receiving a signal reflected back from the node to the AP;
extracting a reflected signal from the received signal; and
estimating time-of-flight and distance from the node to the AP using the extracted signal.

13. A method for determining orientation of a node with respect to an access point (AP) in a mmWave backscatter network, the method comprising:
transmitting a frequency modulated continuous wave (FMCW) signal from an AP to a node;
receiving a signal reflected back from the node to the AP;
identifying frequencies present within the reflected signal; and
determining orientation of the node with respect to the AP based upon the identified frequencies.

14. A method for determining orientation of a node with respect to an access point (AP) in a mmWave backscatter network, the method comprising:
transmitting a triangular chirp frequency modulated continuous wave (FMCW) signal from an AP to a node;
receiving the FMCW signal at the node;
measuring a delay between times receiving the highest power within the received signal; and
estimating orientation based on the delay.
